(19) United States
(12) Patent Application Publication
(10) Pub. No.: US 2003/0015227 A1
(43) Pub. Date: Jan. 23, 2003

(54) Shock wave generating apparatus and apparatus for removing foreign objects on solid body surface using shock wave

(75) Inventors: Kazuyoshi Takayama, Miyagi (JP); Gopalan Jagadeesh, Miyagi (JP); Koji Shibasaki, Chiba (JP); Hiroyuki Mizunaga, Chiba (JP); Shiro Shibasaki, Chiba (JP)

Correspondence Address: GREENBLUM & BERNSTEIN, P.L.C., 1941 ROLAND CLARKE PLACE, RESTON, VA, 20191, US

(73) Assignee: Kazuyoshi TAKAYAMA, Miyagi (JP)

(21) Appl. No.: 10/187,794

(22) Filed: Jul. 3, 2002

(30) Foreign Application Priority Data
Jul. 19, 2001 (JP) 2001-220297

(51) Int. Cl. B08B 3/10

(52) U.S. Cl. 134/184

(57) ABSTRACT

Disclosed are a safe and small-scaled shock wave generating apparatus and effective applications of shock wave generated by the device. Provided in the shock wave generating apparatus are a columnar rotation body, a rotation shaft projected from both end faces of the rotation body towards outside in parallel to the lateral surface of the rotation body, a rotation drive unit for providing predetermined torque to the rotation body through the rotation shaft and a controller for controlling operation of the rotation drive unit. The controller has a function of controlling the operation of the rotation drive unit so that at least a part of the lateral surface of the rotation body spins at a speed higher than the sound velocity under a condition near the periphery of the rotation body.

### BACKGROUND OF THE INVENTION

1. Field of the Invention

The present invention relates to a shock wave generating apparatus and an apparatus for removing foreign objects on the solid body surface using shock wave and, more specifically, to a shock wave generating apparatus using a rotation body and a apparatus for removing foreign objects on the solid body surface using shock wave generated using a rotation body.

2. Description of the Related Art

A great deal of research on shock wave has been carried out in the past to investigate about a principal of its formation and to study application of shock wave to various fields. The disclosed principal of shock wave formation is as follows. First, shock wave will be described.

Shock wave is a wave formed on accordance with a high bursting pressure change or radical changes in energy and the like in the atmosphere and is generated, specifically, near the periphery of an object moving at a speed higher than sound velocity. Here, radically change portion of pressure or density is propagated as the wave at sound velocity in the atmosphere. It is referred to as Mach 1 when the speed of the subject and the sound velocity is the same, and shock wave exceeds Mach 1. As described, shock wave can be defined as a wave with a discontinuously limited pressure increase propagated at a speed exceeding the sound velocity. Sound velocity herein is 331.45 m/sec at 0° C. and 1 atm in the atmosphere.

A specific example of shock wave generation will be described by referring to the case of a flying aircraft. Let's assume now there is an aircraft which produces a sound at the time of departure and continues to produce the sound while flying in one direction.

First, a case is considered in which the flying speed is lower than sound velocity. Provided that sound velocity is “a” and the speed of the aircraft is “u”. A stand-off distance between the wave face of the first sound propagated in the flying direction and the aircraft after “t” hour flight from the departure is (a−u) t. If the flying speed and sound velocity is the same, all the sound of the aircraft stays adhered on the tip and the sound is propagated to the space behind the aircraft. If the flying speed exceeds sound velocity, although the wave faces of all the sound are adhered to the tip of the body of the aircraft, the sound is transmitted only to the space inside a cone with semi-apex angle sin⁻¹ (a/u) having the tip of the aircraft as the apex since the flying speed exceeds sound velocity. Normally, the amount of increase in the pressure across the sound wave is extremely small and is negligible. In the case where the sonic wave is accumulated highly collective, however, the pressure discontinuously increases exhibiting a limited value thereby generating shock wave.

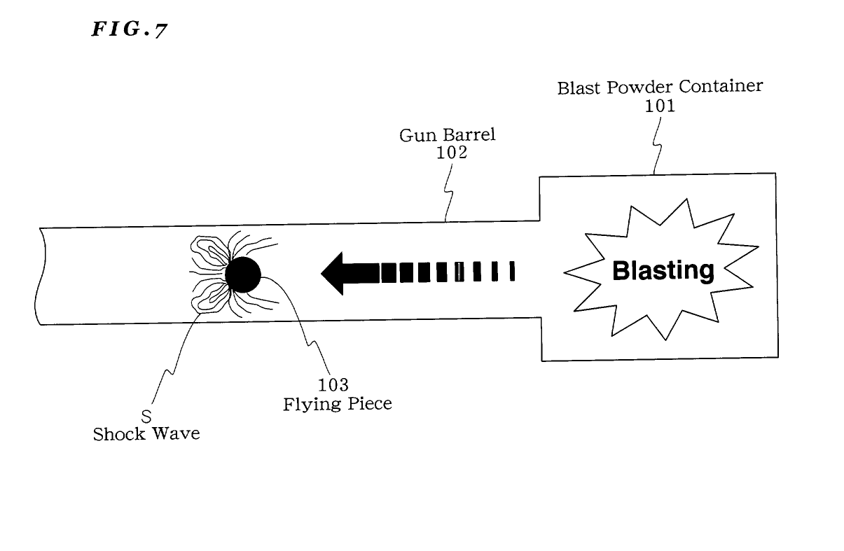

A method of generating the shock wave in the related art is shown in FIG. 7. As shown in FIG. 7, a shock wave generating apparatus in the related art comprises gunpowder inside a blast powder container 101 and, by the blasting energy, a flying piece 103 is flown inside a gun barrel 102. When the flying piece 103 flies at a sound velocity, a shock wave S is generated from the flying piece 103. Data of the shock wave S obtained as described has been used for analysis.

However, the above-mentioned shock wave generating apparatus in the related art has problems as described below. First, although it is possible to adjust the energy by controlling the amount of gunpowder, it is difficult to fully control shock wave generating since there generates errors in the expected energy to some extent. At this time, presumption and correction are possible to some extent by calculation, however, the content of the shock wave being generated varies. Also, it requires a sufficient preparation for shock wave generating since gunpowder must be handled with care.

In addition, when using a apparatus as shown in FIG. 7, the length of the gun barrel becomes some meters to some ten meters so that the scale of the apparatus becomes extremely large. Therefore, there causes a various kinds of problems such as the space for placing the apparatus, making an arrangement for a test beforehand, and a cost performance of a apparatus.

As described above, shock wave generating itself is difficult so that it is hard to obtain opportunities to measure the shock wave for analysis. Therefore, the shock wave has not been sufficiently utilized since analysis of the shock wave itself is difficult and the apparatuses used therein are large-scaled.

### SUMMARY OF THE INVENTION

The present invention has been designed to overcome the foregoing problems. An object of the invention is to provide an improved, safe, small-scaled shock wave generating apparatus and effectively utilize the shock wave generated by the apparatus.

A shock wave generating apparatus of the invention comprises: a rotation body having a predetermined three-dimensional shape; a rotation shaft to be the rotation center of the rotation body; a rotation drive unit for providing predetermined torque to the rotation body through the rotation shaft; and a controller for controlling operation of the rotation drive unit. The controller has a function of controlling the operation of the rotation drive unit so that at least a part of rotor edges of the rotation body spins at a speed higher than sound velocity under a condition near the periphery of the rotation body.

Also, it is desirable that the shock wave generating apparatus of the invention comprises: a columnar rotation body; a rotation shaft projected from both end faces of the rotation body towards outside in parallel to a lateral surface of the rotation body; a rotation drive unit for providing predetermined torque to the rotation body through the rotation shaft; and a controller for controlling operation of the rotation drive unit. The controller has a function of controlling the operation of the rotation drive unit so that at least a part of the lateral surface of the rotation body spins at a speed higher than sound velocity under a condition near the periphery of the rotation body.

With the configuration mentioned above, the rotation body spins with the lateral surface being the rotor edges by torque being applied to the rotation shaft from the rotation drive unit. At this time, the relation between the output of the rotation drive unit and the rotation speed of the rotation body is stored in the controller and the controller controls the rotation body to spin so that the speed of the lateral surface of the rotation body reaches the sound velocity. When the speed of the lateral surface of the rotation body reaches the sound velocity, shock wave is generated in the area of the lateral surface whose speed has reached the sound velocity. Accordingly, shock wave can be generated through the configuration in which a rotation body is rotated. Therefore, reducing the scale and weight of the apparatus can be achieved, which leads to a decrease in the manufacturing cost. As a result, more opportunities can be obtained for shock wave generating to be used for research and development of its application technology. Also, experiments and the like can be carried out safely since, unlike in the related art, there is no need for the apparatus to use gunpowder.

Also, it is desirable that the rotation body of the invention is cylindrical shape. There may be protrusions formed on the lateral surface of the rotation body being protruded from the lateral surface. Also, slots may be formed on the lateral surface being cut our to the inner direction of the rotation body. The rotation shaft is located in the center of the cylinder so that the rotation body can be balanced when spinning and can achieve stabilization when spinning at a high-speed. The peripheral surface reaches the sound velocity uniformly so that the amount of the generated shock wave can be increased. In addition, because of the protrusions and the slots formed on the lateral surface, there generates airflow in each area. As a result, shock wave can be more effectively generated.

Also, a housing for covering the rotation body is provided thereby to cover the rotation body spinning at a high-speed. Therefore, a apparatus with a high safety can be provided. In this case, a gas is stored inside the housing thereby promoting an increase in the pressure and temperature around the rotation body. As a result, the shock wave generating can be further promoted.

Furthermore, the invention provides a apparatus for removing foreign objects on the solid body surface comprising: a columnar rotation body; a rotation shaft projected from both end faces of the rotation body towards outside in parallel to a lateral surface of the rotation body; a rotation drive unit for providing predetermined torque to the rotation body through the rotation shaft; a controller for controlling operation of the rotation drive unit; and a holder for supporting a predetermined solid body near the rotation body with its surface facing the lateral surfaces of the rotation body. The controller has a function of controlling the operation of the rotation drive unit so that at least a part of the lateral surface of the rotation body spins at a speed higher than sound velocity in the atmosphere. At this time it is preferable that the solid body be a semiconductor wafer.

With the configuration as described above, first, as described, the shock wave is generated when the rotation speed of the lateral surface of the rotation body reaches the sound velocity. The shock wave is propagated to the object placed with its surface facing the lateral surface of the rotation body. At this time, the strong and unstable vortex shedding by the shock wave removes the foreign objects adhered inside the micron size slots formed on the solid body surface. Therefore, it can be used as a small-scaled and inexpensive apparatus for removing the foreign objects at low cost for a semiconductor wafer and the like which requires an non-contact cleaning.

### BRIEF DESCRIPTION OF THE DRAWAINGS

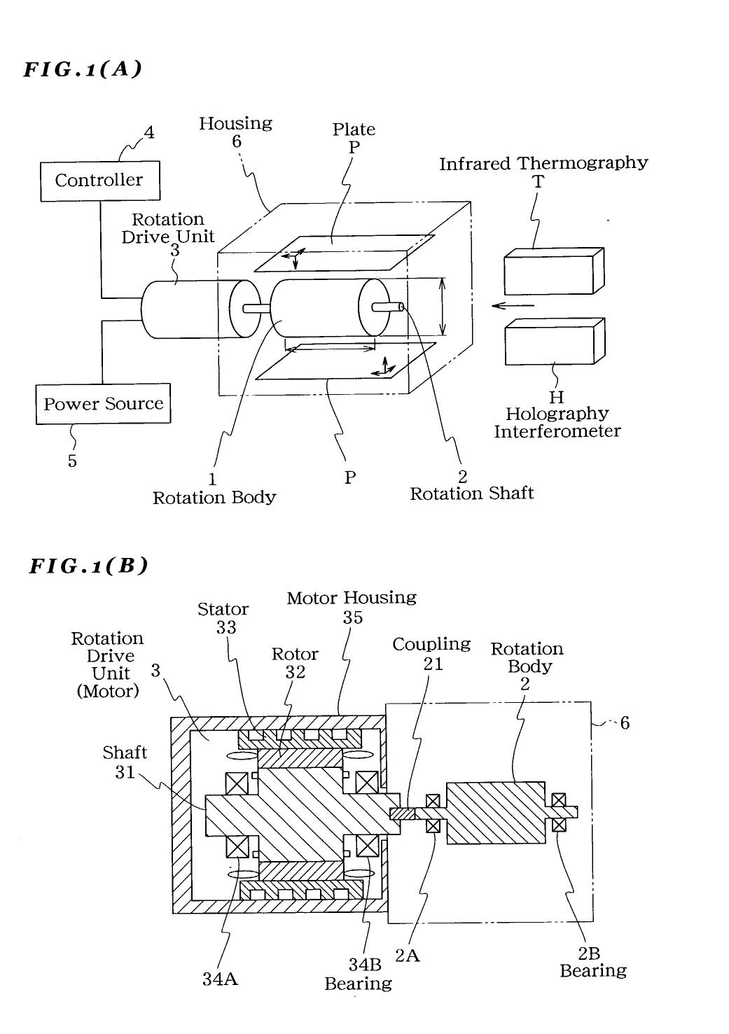

FIGS. 1A and 1B are illustrations showing the configuration according to the first embodiment of the invention and, specifically, FIG. 1A is a schematic diagram according to the embodiment and FIG. 1B is a model diagram of the cross section;

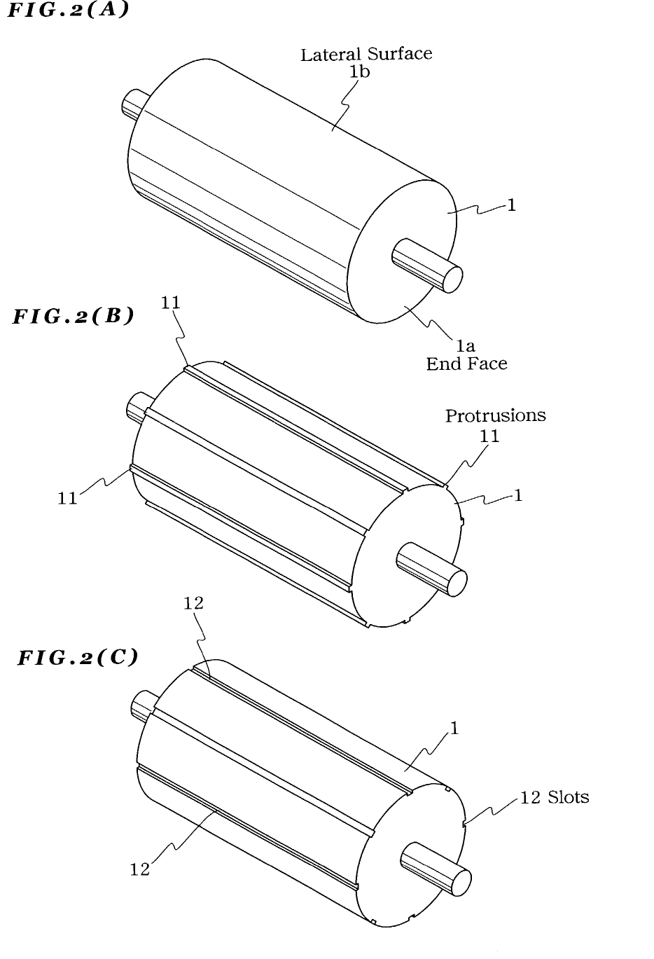

FIGS. 2A, 2B, and 2C are perspective views showing the rotation body disclosed in FIGS. 1A and 1B, each of which is an example of a rotation body;

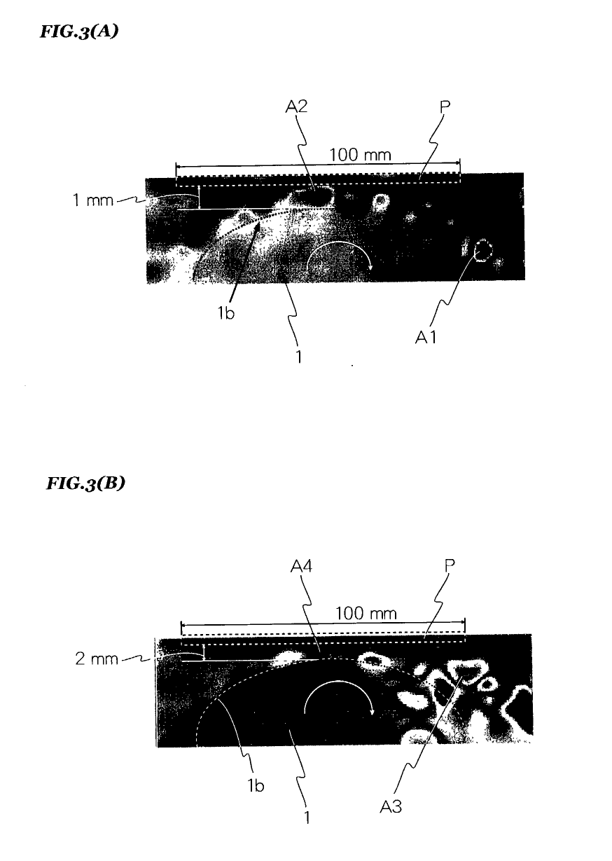

FIGS. 3A and 3B are illustrations of visualized flow field around the rotation body and, specifically, FIG. 3A shows the case where there is 1 mm stand-off distance between the rotation body while FIG. 3B shows the case of 2 mm stand-off distance;

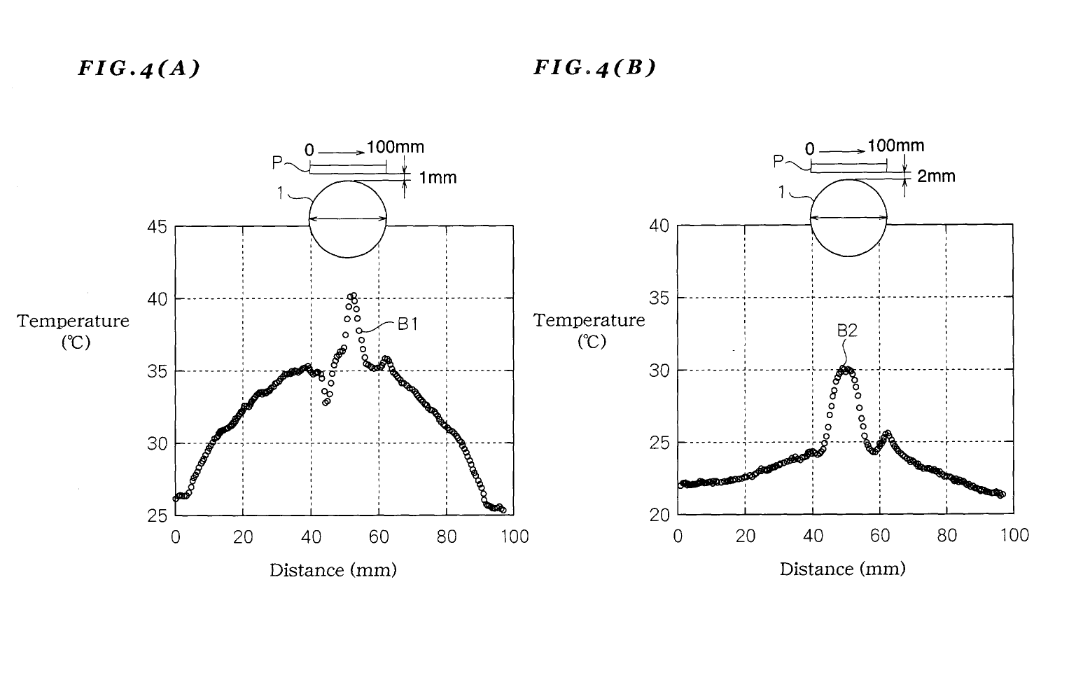

FIGS. 4A and 4B are figures showing the temperature distribution around the rotation body and, specifically, FIG. 4A shows the case where there is 1 mm stand-off distance between the rotation body while FIG. 4B shows the case of 2 mm stand-off distance;

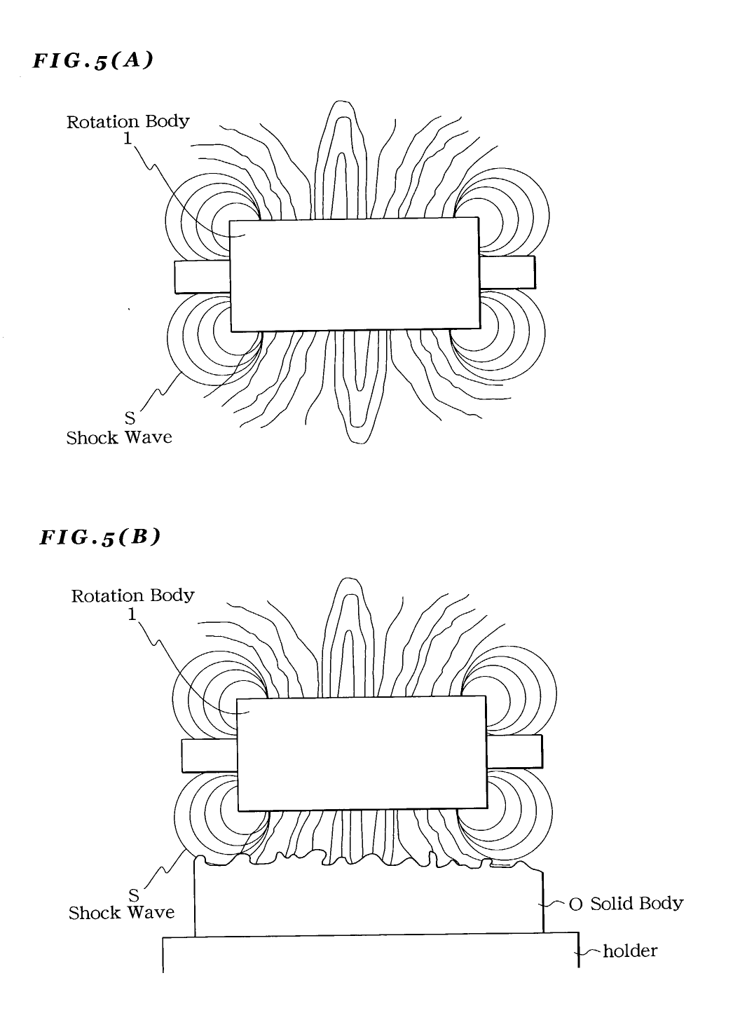

FIGS. 5A and 5B are explanatory illustrations showing shock wave generated around the rotation body and, specifically, FIG. 5A shows the example and FIG. 5B shows an example of the case where shock wave is propagated to a semiconductor wafer;

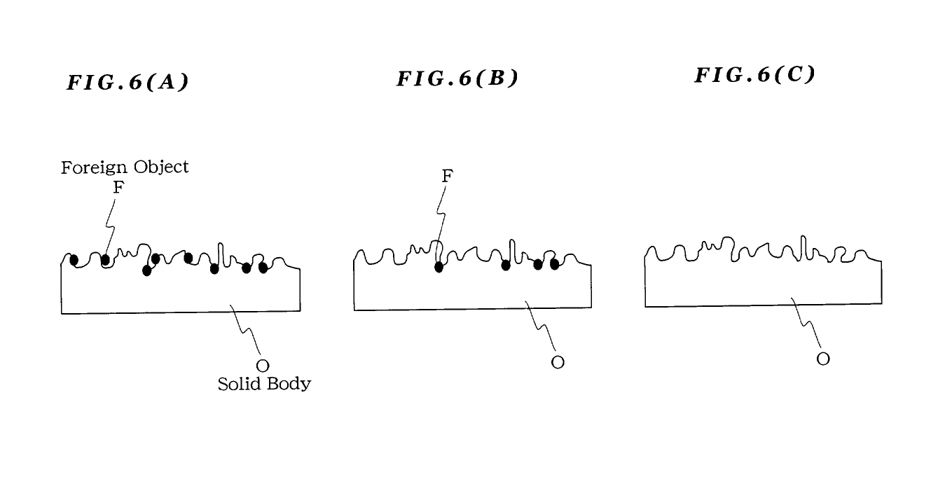

FIGS. 6A, 6B, and 6C are explanatory illustrations showing an example of removing foreign objects on the solid body surface using shock wave and, specifically, FIG. 6A is an illustration showing the solid body surface at the initial state, FIG. 6B is an illustration showing the case where the foreign objects on the solid body surface are removed by a cleaning technique in the related art such as etching, and FIG. 6C is an illustration showing the case where the foreign objects on the solid body surface are removed using shock wave;

FIG. 7 is an explanatory figure showing a method of shock wave generating in the related art; and

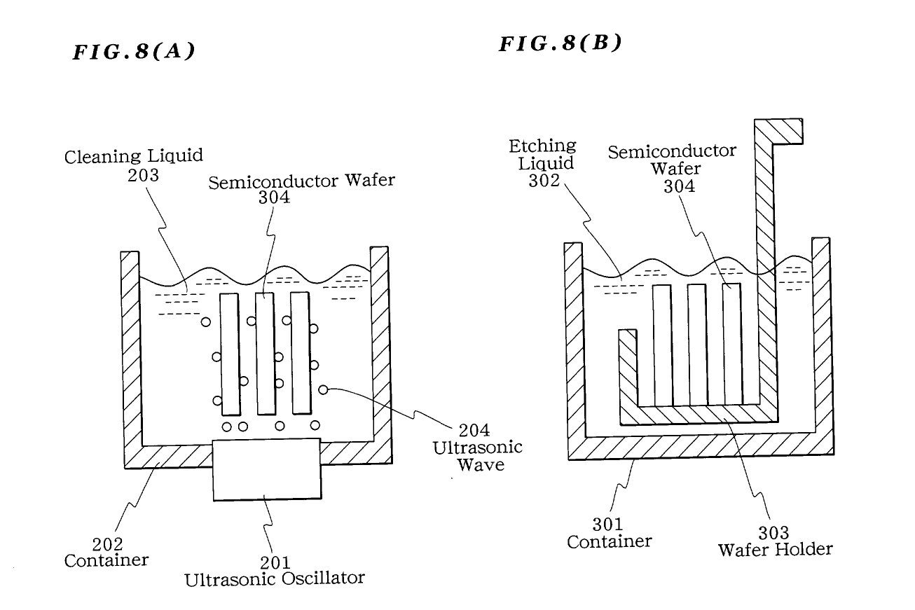

FIGS. 8A and 8B are illustrations showing the related art methods of removing the foreign objects adhered on the surface of a semiconductor wafer and, specifically, FIG. 8A shows a removing method using ultrasonic wave and FIG. 8B shows a removing method using an etching liquid.

### DETAILED DESCRIPTION OF THE PREFERRED EMBODIMENTS

First Embodiment

A first embodiment of the invention will be described hereinafter by referring to FIGS. 1A, 1B to FIGS. 5A, 5B. FIGS. 1A and 1B show the configuration of the first embodiment. FIGS. 2A, 2B, and 2C are perspective views showing a rotation body. FIGS. 3A and 3B are illustrations of visualized flow of gas around the rotation body. FIGS. 4A and 4B are figures showing temperature distribution around the rotation body. FIGS. 5A and 5B are explanatory illustrations for describing shock wave generated in the rotation body.

The Whole Configuration

First, the configuration of the shock wave generating apparatus according to the invention will be described by referring to FIGS. 1A and 1B. FIG. 1A is a schematic diagram showing the configuration and FIG. 1B is a model diagram of the cross section.

As shown in FIG. 1A, the shock wave generating apparatus of the invention comprises a columnar rotation body 1, a rotation shaft 2 projected from both end faces 1a of the rotation body 1 towards outer side in parallel to a lateral surfaces 1b of the rotation body 1, a rotation drive unit 3 for applying a predetermined torque on the rotation body 1 through the rotation shaft 2, a controller 4 for controlling the operation of the rotation drive unit 3, and a power source 5 for supplying the electric power to the rotation drive unit 3. The shock wave generating apparatus is to generate shock wave in the lateral surfaces 1b by rotating the lateral surfaces 1b of the rotation body 1 in the sound velocity near the peripheral of the rotation body 1. Detailed description will be provided in the followings.

Rotation Body

The rotation body 1 will be described by referring to FIGS. 2A, 2B and 2C. FIG. 2A is a perspective view showing an example of the rotation body 1 while FIG. 2B and FIG. 2C show other examples, respectively. FIGS. 2A and 2B will be described later.

As shown in FIG. 2A, the rotation body 1 according to the embodiment is a cylindrical member and formed of aluminum alloy. The rotation body 1 is formed to have a configuration in which the length between the both end faces is longer than the diameter of the end face 1A with circular shape. The rotation shaft 2 is provided along in the longitudinal direction of the rotation body 1 so as to pierce through the center of each end face 1A. The rotation shaft 2 is fixed to the rotation body 1 and rotates as one body. The rotation shaft 2 may also be projected from the both end faces 1A of the rotation body 1 towards the outer side. In other words, the rotation shaft 2 is not necessarily in the form which pierces through inside the rotation body 1 but may be formed as one body as the rotation body 1 by molding. Also, the shape of the rotation body 1 is not limited to the one mentioned above as will be described later. Furthermore, the kind of material used for the rotation body 1 is not limited to the one mentioned above.

The rotation body 1 according to the embodiment is 110 mm in the diameter D and 150 mm in length. As will be described later, the rotation body 1 is rotated by torque applied from the rotation drive unit 3 through the rotation shaft 2. The lateral surfaces of the rotation body 1 when rotated, that is, the velocity V m/sec of the lateral surface of the cylinder is, provided that rotation number of the cylinder is N rpm,

V m/sec=(D mm×π×N rpm)/60,000

Here, π is the ratio of the circumference of a circle to its diameter. If N=60,000 rpm, then V=345 m/sec, which means to exceed the sound velocity in the above-mentioned atmosphere. The above-mentioned atmosphere, however, is the space around the rotation body 1 and the value of the sound velocity varies depending on the characteristic of the gas, pressure and temperatures inside the space.

Since the rotation body 1 needs to perform stable operation, both of the ends of the rotation shaft 2 are supported by bearings 2A and 2B as shown in FIG. 1B. The bearings 2A and 2B comprises a water supply (not shown in figure) for supplying cool water. Also, axial vibration and bearing temperature are monitored in various positions and a safety apparatus (not shown) is provided for turning off the switch in case of emergency. It is designed so that the bearing temperature does not increase to 20° C. or more in 10-minute operation at 60,000 rpm. The axial vibration and the bearing temperatures are measured by an acceleration sensor (not shown), an infrared thermography T shown in FIG. 1A and the like.

Furthermore, a housing 6 for covering the rotation body 1 is provided outside the rotation body 1. The housing 6 is fixed to other adjacent device. The housing 6 may be formed of any material having enough rigidity for static vibration such as chattering.

The housing 6 houses the rotation body 1 inside and may be provided to seal the part where the rotation body 1 is being placed. Also, a vacuum pump (not shown) may be provided with the housing 6. The air pressure inside the housing 6 can be lowered by operating the vacuum pump. By lowering the air pressure around the rotation body 1 than the atmosphere as described, resistance to the lateral surfaces 1B of the rotation body 1 decreases so that the load on the rotation drive unit 3 which applies torque to the rotation body 1 is suppressed and the rotation speed of the lateral surfaces 1B of the rotation body 1 can rapidly reach the sound velocity. However, the way which decreases the pressure inside the housing 6 is not limited to the above-mentioned vacuum pump. Also, it is not necessary to evacuate inside the housing 6. The sound velocity herein is the value in the sound velocity under such as the air pressure, temperature and the like inside the housing 6 where the rotation body 1 is placed. Specifically, it is the value of the sound velocity in near the lateral surfaces 1B of the rotation body 1.

Also, two pieces of plate P are placed inside the housing 6 as shown in FIG. 1A. The plates P are provided, assuming that there is a surface in contact with the lateral surfaces 1B of the rotation body 1, in parallel to the surface with a predetermined distance from the rotation body 1. In other words, the plates P are supported by the housing 6. The plates P, as will be described later, are used when measuring the shock wave S which is generated in the rotation body 1. The size of the plate P is 100 mm in a side on the end face 1a side of the rotation body 1 and 150 mm in a side on the lateral surfaces 1b side. That is, it is almost identical to the shape reflecting the cylinder, which is the rotation body 1.

As described, torque is applied to the rotation body 1 by the rotation drive unit 3. At this time, the rotation drive unit 3 and one end of the rotation shaft 2 are coupled through a coupling 21 thereby transmitting the rotation force. The coupling 21 has little influence on the rotational vibration.

Rotation Drive Unit

The rotation drive unit 3 is a motor 3 capable of a high-speed rotation and the cross section is shown in FIG. 1B. The rotation drive unit 3 as a motor comprises a shaft 31, a rotor 32, a stator 33 and bearings 34A and 34B. Specifically, the rotor 32 is inserted inside the stator 33 and the shaft 31 is assembled with a fitting interference for the rotation body 32. After being fixed to the rotation body 32, the shaft 31 is supported by the bearings 34A and 34B at both ends. These are housed in a motor housing 35. There may be a cooling mechanism using cool air, cool water and the like provided inside the motor housing 35 in order to protect the motor. A predetermined amount of power is supplied from a power source 5 to the motor 3 and the controller 4 controls the operation of the motor 3 so as to control the number of rotation.

Controller

The controller 4 is a computer having a predetermined arithmetic processing capacity. Also, the controller 4 has a function of controlling the rotation speed of the motor 3, that is, the above-mentioned rotation drive unit 3. Accordingly, the rotation speed of the motor 3 is to be fed back to the controller 4 by electric signals and, based on the signals, the controller 4 gives a drive instruction to the motor 3. A program for such function is stored beforehand to a storage unit (not shown) inside the computer, that is, the controller 4. By loading the program to a CPU (not shown), the above-mentioned function can be achieved.

Also, the above-mentioned control program contains a drive instruction for the motor 3 so that the speed of the lateral surfaces 1B of the above-mentioned rotation body 1 reaches the sound velocity. For example, the rotation body 1 according to the embodiment reaches the sound velocity by spinning at 60,000 rpm. Thus, the program contains an instruction to rotate such number of times. However, the rotation number is not limited to the above-mentioned case but may also be the numbers that are less or more than the number reaching the sound velocity. It may also comprise an input unit (not shown) connected to the controller 4 to which the controlled rotation number of the motor 3 is inputted by a worker so as to be reflected upon the above-mentioned program. Thereby, the speed of the lateral surfaces 1B of the rotation body 1 can be changed at will.

Measurement

Next, the shock wave generating will be described by visualizing and measuring the air flow field generated around the above-mentioned rotation body 1. In the experiment, a holography interferometer H (see FIG. 1A) using a laser was used and a CCD camera (not shown) was used to take pictures. At that time, operation of the laser was controlled by a predetermined computer. FIG. 3A shows the flow field around the rotation body 1 when the stand-off distance between the plate P and the rotation body was 1 mm. FIG. 3B shows the flow field when the stand-off distance between the plate P was 2 mm.

In FIG. 3A and FIG. 3B, a flow of a strong vortex shedding (A1 and A3) is recognized near the rotation body 1 on the right-hand side of the drawing. Also, the flow properties drastically change in a region where the gap between the rotation body 1 and the plate P is minimum and the regions (A2 and A4) appear to be local hot spots.

The temperature distribution measured around the rotation body 1 at 50,000 rpm at a stand-off distance of 1 mm between the rotation body 1 is shown in FIG. 4A and the one at a stand-off distance of 2 mm is shown in FIG. 4B. The horizontal axis herein represents the stand-off distance from the left end of the plate P. Therefore, the area around the stand-off distance of 50 mm corresponds to the region where the stand-off distance between the rotation body 1 and the plate P is minimum.

From these figures, the thermal spikes (B1 and B2) by the local hot spots can be clearly recognized in the region with a stand-off distance of 50 mm. Therefore, the drastic increase in the measured temperature verifies that the flow properties drastically change in the narrow region with a stand-off distance of several mm between the rotation body 1 and the surface of the flat plates P.

As described above, since the shock wave can be defined as a wave surface in which the pressure and temperatures change discontinuously, when the rotation speed of the lateral surfaces 1B of the rotation body 1 increases, the measured hot spots (A2 and A4) described above substantially coalesce forming the shock wave. Thereby, for example, the shock wave S is generated around the rotation body 1 as shown in FIG. 5A. The lines in the illustrations show an example of the condensation and rarefaction of the pressure of the generated shock wave S.

By spinning the rotation body 1 at a high-speed in the manner as described, that is, by rotating the lateral surface 1B of the rotation body 1 at the sound velocity, the shock wave S can be generated in the rotation body 1. Therefore, a shock wave generating apparatus can be constituted with the configuration as described so that a small-scaled and inexpensive shock wave generating apparatus can be provided. Also, safety can be improved. Furthermore, by using the device, research on the shock wave can be promoted and further application to various fields can be investigated.

The case where the above-mentioned rotation body 1 is a cylinder has been shown as an example, however, it is not limited to the case. For example, the rotation body 1 may be a triangular prism, quadrangular prism or polygonal prism. Moreover, it may even take shapes other than columnar shape. Also, a protrusion 11 may be formed on the lateral surfaces 1b of the, above-mentioned cylinder being protruded from the lateral surface 1b and a slot 12 being cut out from the lateral surfaces 1b towards inner direction of the rotation body may be formed. The examples are shown in FIGS. 2B and 2C.

As shown in FIG. 2B, the protrusions 11 in a straight-line form are provided in the lateral surface 1b of the cylinder along the rotation shaft 2 at predetermined intervals. A plurality of protrusions 11 are provided in the lateral surface 1b at the predetermined intervals. As a result, the air around the protrusions 11 is pressed when the rotation body 1 is rotated. Therefore, the air is more compressed, which leads to an increase in the pressure and temperature thereby accelerating the shock wave generating.

In the case shown in FIG. 2C, a plurality of slots 12 with a predetermined depth are provided in the lateral surfaces 1b of the rotation body 1 in contrast to the above-mentioned case with the protrusions 11. With this configuration, the shock wave generating can be also accelerated as in the case of providing the protrusions 11. Therefore, the shock wave can be effectively generated.

Incidentally, the above-mentioned protrusions 11 and the slots 12 are not limited to the ones that are provided in a straight-line form along the rotation shaft. The same effect as mentioned above can be obtained with the protrusions 11 and slots 12 in any form provided in the lateral surfaces 1b of the rotation body 1. The shape of the rotation body 1 in which the protrusions 11 and slots 12 are provided is not limited to cylinder.

Second Embodiment

The second embodiment of the invention will be described hereinafter by referring to FIGS. 5A, 5B and FIGS. 6A to 6C. FIGS. 5A and 5B, as described, show the shock wave S generated around the rotation body 1. Specifically, FIG. 5B is an illustration showing the case where the shock wave S is propagated to a semiconductor wafer. FIGS. 6A to 6C are explanatory illustrations showing an example where a foreign object F adhered to the surface of the semiconductor wafer is removed using the shock wave S.

Configuration

In the second embodiment of the invention, in addition to the structural elements of the first embodiment mentioned above, a holder is provided for supporting the surface of a predetermined solid body O near the rotation body 1 facing the lateral surfaces 1b of the rotation body 1. The shock wave S is generated in the surface of the solid body O such as a semiconductor wafer supported by the holder so as to remove the foreign object F such as dust adhered between the concaves and convexes on the surface of the semiconductor wafer. In other words, it is application of the shock wave S to a apparatus for removing foreign objects on the surface of the solid body O.

Method of Removing Foreign Objects in the Related Art

By referring to FIGS. 8A and 8B, a cleaning technique of the wafer surface in a wafer processing of a semiconductor used in the related will be described. There are a lot of micron size concaves and convexes on the surface of the wafer and the foreign objects existed therebetween deteriorate the property of the semiconductor. Therefore, it is necessary to remove the foreign objects beforehand during the step of processing. FIG. 8A shows an ultrasonic cleaning technique and FIG. 8B shows a technique by etching.

As shown in FIG. 8A, in an ultrasonic cleaning, first, a cleaning liquid 203 is poured inside a container 202 comprising an ultrasonic oscillator 201. Then, a semiconductor wafer 205 is soaked into the cleaning liquid 203. In this manner, the foreign objects on the surface of the semiconductor wafer 205 soaked in the cleaning liquid 203 can be removed by an ultrasonic wave 204 oscillated from the ultrasonic oscillator 201.

In a cleaning by etching as shown in FIG. 8B, first, an etching liquid 302 is poured inside a container 301. Then, a semiconductor wafer 304 is soaked in the etching liquid 302 while being supported by a wafer support 303. Thereby, the foreign objects on the surface of the semiconductor wafer 204 can be removed.

However, the related art cleaning technique of the foreign objects on the wafer surface described above cannot remove the foreign objects in the inner part of the concaves and convexes on the wafer surface. Therefore, there causes a problem of product yield loss, which is one of the main factors for being unable to reduce the cost of manufacturing a semiconductor. It is believed that there is about an 80 percent product yield loss in wafer processing due to the foreign objects remained on the wafer surface. Thus, there is an urgent need for an non-contact type device as in the invention for removing the foreign objects adhered inside the concaves and convexes on the wafer surface.

Wafer Holder

Next, the structural elements in the above-mentioned second embodiment will be described. A holder which is a structural element additionally provided in the embodiment is for supporting a solid body O near the rotation body 1 generating the shock wave S. At this time, the solid body O is placed with its surface, which is a subject for removing the foreign object, facing the lateral surface of the rotation body 1. The stand-off distance between the rotation body 1 and the solid body O is to be about, for example, 1 mm. In other words, the solid body O is placed in the same position as the plates P described in the above-mentioned first embodiment.

The holder, for example, is a belt conveyor and a semiconductor wafer is placed thereon. If the housing 6 is provided in the device, a part of the housing 6 is cut out so that the belt conveyor can pass through inside the housing 6. The belt conveyor is provided to operate under the rotation body 1. Therefore, the whole surface of the semiconductor wafer is to be carried and passed through under the rotation body 1 so that the shock wave S is propagated to the whole surface of the semiconductor wafer.

FIGS. 6A, 6B, 6C are explanatory illustrations showing an example of removing the foreign objects on the surface of the solid body O using the shock wave S. Specifically, FIG. 6A shows the solid body O at the initial state on which no cleaning or the like has been performed. There are micron size concaves and convexes, as shown in figure, on the surface of the solid body O and the foreign object F exists therebetween.

FIG. 6B shows the case where the foreign objects on the surface of the solid body is removed by cleaning techniques in the related art such as ultrasonic wave or etching. The techniques in the related art can remove the foreign objects in the shallow region of the concaves and convexes on the solid body surface, however, it can not completely remove the foreign objects in the deep region of the concaves and convexes. Therefore, the foreign object F left behind is to remain even after cleaning.

FIG. 6C shows the case where the foreign objects on the solid body surface are removed using the shock wave. There are no foreign objects remained in the concaves and convexes on the surface of the solid body O. Hence, the cleaning properties can be remarkably improved.

Accordingly, as shown in FIG. 5B, it becomes possible to remove the foreign objects on the solid body surface by applying the shock wave S generated in the rotation body 1 onto the surface of the solid body O. Specifically, the shock wave S is capable of removing the foreign object F deep inside the concaves and convexes on the surface of the solid body O by cavitation and the like, which cannot be performed by the cleaning techniques in the related art. Not only the shock wave S but a rarefaction wave generated on the surface of the rotation body 1 also works for the non-contact removal of the foreign object F on the solid body surface.

Theoretical estimation of total adhesive force acting on a 0.15 μm diameter particle adhering to the semiconductor wafer surface is about 9.5 m-dyne. Although this value is extremely small, the force per unit area of the particles increases exponentially with the decrease in particle diameter. On the other hand, the typical value of the turbulent drag force for a 0.15 μm diameter particle subjected to free stream velocity of 300 m/sec is about 85 m-dyne. In short, the turbulent drag force acting on the particle by the shock wave is about 8 times larger than the adhesive force. Therefore, the foreign object F such as dust on the wafer surface can be effectively removed by the device.

An example of the case where the solid body O is a semiconductor wafer has been described above, however, it is not limited to the case. The invention is effectively applied by setting the solid body O, which requires an non-contact removal of the foreign objects adhered to the surface, in the device according to the embodiment.

Third Embodiment

The third embodiment of the invention, as in the above-mentioned second embodiment, is a apparatus for removing the foreign objects on the solidbody surface. It is different from the second embodiment in that the foreign objects on the surface of the fixed solid body O is removed by moving the apparatus side against the solid body O instead.

The configuration will now be described. In the third embodiment, a surface of the housing 6 provided in the above-mentioned first embodiment is cut out. The shock wave S generated in the rotation body 1 inside the housing 6 is propagated to the solid body O by bringing the cut-out part of the housing 6, which is the aperture, to the solid body O to be the subject. Accordingly, the apparatus is designed to be compact so that a worker can move the device itself on the surface of the solid body O. Also, a handle is provided in the device so that the worker can move the apparatus easily. The handle is a short stick-like member long enough to provide a portion to be grabbed and the rotation body 1 and the motor 3 are provided in the tip. Therefore, the device can be easily made compact by reducing the size of the rotation body 1. Thus, the device can be operated by one hand.

Specifically, the solid body O, for example, is a body of an aircraft and the apparatus can be used for removing the painting on the body. In other words, the painting on the body can be removed by the shock wave from the rotation body 1 of the apparatus by having the worker move the apparatus over the surface of the aircraft body. Thereby, the painting can be removed with no contact and damages on the surface underneath can be suppressed.

The invention has such configuration and functions as described. Hence, the shock wave can be generated in the lateral surface of the rotation body by rotating the lateral surface of the rotation body at the sound velocity or higher. As a result, the shock wave can be easily generated with a simple configuration and, while achieving simplification of the device, achieve a decrease in the size, reduction of the cost and improvement in its safety. Consequently, excellent effects can be obtained that are not of the related art such as an increase in the opportunities for more research on the shock wave and expanding its application field.

Furthermore, in the case where the rotation body is a cylindrical member, the rotation body can be in balance so that the safety of the device can be improved and the lateral surface of the rotation body uniformly reaches the sound velocity. Therefore, the shock wave can be generated in the whole surface of the rotation body. In the case where the protrusions and slots are provided in the lateral surface of the rotation body, there is a change in the airflow around the rotation body due to the protrusions and the slots. Thus, the shock wave can be effectively generated.

Moreover, in the case where a holder for supporting a solid body is provided near the rotation body, the solid body such as a semiconductor wafer can be placed near the rotation body with its surface facing the lateral surface of the rotation body. As a result, the shock wave generated in the rotation body is propagated to the surface of the wafer. Therefore, the micron size foreign objects adhered between the concaves and convexes formed on the wafer surface can be easily removed by the shock wave with no contact. Consequently, the steps of manufacturing a semiconductor wafer can be simplified and the manufacturing cost can be reduced.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-220297 (Filed on Jul. 19, 2001) including specification, claims, drawings and summary are incorporated herein by reference in its entirety.

What is claimed is:

1. A shock wave generating apparatus comprising: a rotation body having a predetermined three-dimensional shape; a rotation shaft to be a rotation center of the rotation body; a rotation drive unit for providing predetermined torque to the rotation body through the rotation shaft; and a controller for controlling operation of the rotation drive unit, wherein:
the controller has a function of controlling the operation of the rotation drive unit so that at least a part of rotor edges of the rotation body spins at a speed higher than sound velocity under a condition near the periphery of the rotation body.

2. A shock wave generating apparatus comprising: a columnar rotation body; a rotation shaft projected from both end faces of the rotation body towards outside in parallel to a lateral surface of the rotation body; a rotation drive unit for providing predetermined torque to the rotation body through the rotation shaft; and a controller for controlling operation of the rotation drive unit, wherein:
the controller has a function of controlling the operation of the rotation drive unit so that at least a part of the lateral surface of the rotation body spins at a speed higher than sound velocity under a condition near the periphery of the rotation body.

3. The shock wave generating apparatus as claimed in claim 2, wherein the rotation body has a cylindrical shape.

4. The shock wave generating apparatus as claimed in claim 2, wherein protrusions are formed on the lateral surface of the rotation body being protruded from the lateral surfaces.

5. The shock wave generating apparatus as claimed in claim 3, wherein protrusions are formed on the lateral surface of the rotation body being protruded from the lateral surfaces.

6. The shock wave generating apparatus as claimed in claim 2, wherein slots are formed on the lateral surface of the rotation body being cut out from the lateral surface towards inner direction of the rotation body.

7. The shock wave generating apparatus as claimed in claim 3, wherein slots are formed on the lateral surface of the rotation body being cut out from the lateral surface towards inner direction of the rotation body.

8. The shock wave generating apparatus as claimed in claim 4, wherein slots are formed on the lateral surface of the rotation body being cut out from the lateral surface towards inner direction of the rotation body.

9. The shock wave generating apparatus as claimed in claim 5, wherein slots are formed on the lateral surface of the rotation body being cut out from the lateral surface towards inner direction of the rotation body.

10. The shock wave generating apparatus as claimed in claim 2, wherein a housing for covering the rotation body is provided.

11. The shock wave generating apparatus as claimed in claims 3, wherein a housing for covering the rotation body is provided.

12. The shock wave generating apparatus as claimed in claim 4, wherein a housing for covering the rotation body is provided.

13. The shock wave generating apparatus as claimed in claim 5, wherein a housing for covering the rotation body is provided.

14. A apparatus for removing foreign objects on a solid body surface using shock wave, comprising: a columnar rotation body; a rotation shaft projected from both end faces of the rotation body towards outside in parallel to a lateral surface of the rotation body; a rotation drive unit for providing predetermined torque to the rotation body through the rotation shaft; a controller for controlling operation of the rotation drive unit; and a holder for supporting a predetermined solid body near the rotation body with its surface facing the lateral surfaces of the rotation body, wherein:
the controller has a function of controlling the operation of the rotation drive unit so that at least a part of the lateral surface of the rotation body spins at a speed higher than sound velocity in the atmosphere.

15. The apparatus for removing foreign objects on a solid body surface using shock wave as claimed claim 14, wherein the solid body is a semiconductor wafer.
